(19) United States
(12) Patent Application Publication
(10) Pub. No.: US 2009/0164916 A1
(43) Pub. Date: Jun. 25, 2009

(54) METHOD AND SYSTEM FOR CREATING MIXED WORLD THAT REFLECTS REAL STATE

(75) Inventors: Eui-Heon JEONG, Suwon-si (KR); Yeong-Geol KIM, Yongin-si (KR); So-Jin KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/339,606

(22) Filed: Dec. 19, 2008

(30) Foreign Application Priority Data
Dec. 21, 2007 (KR) 10-2007-0135612

(51) Int. Cl. G06F 3/048

(52) U.S. Cl. 715/753

(57) ABSTRACT

A method and system for creating a mixed world that reflects a real state is provided. The system includes a mirror world creation module which creates a mirror world that represents the structure of a real world; an object information collection module which collects real object information; and a mixed world creation module which creates a mixed world by reflecting the real object information into the mirror world.

### CROSS-REFERENCE TO RELATED APPLICATION

This application claims priority from Korean Patent Application No. 10-2007-0135612 filed on Dec. 21, 2007 in the Korean Intellectual Property Office, the disclosure of which is incorporated herein by reference in its entirety.

### BACKGROUND OF THE INVENTION

1. Field of the Invention

Methods and systems consistent with the present invention relate to a method and system for creating a mixed world that reflects a real state, and, more particularly, to a method and system for creating a mixed world into which a virtual world and a real world are mixed by reflecting the circumstances of reality

2. Description of the Related Art

Due to recent developments in the field of mobile communication networks and the rapid growth of wireless network environments, people can now send and receive instant messages, perform online conversation or make and receive a video call with their mobile phones or other mobile communication devices.

In addition, people can send and receive instant messages using avatars in Internet-based chat rooms or online games. Avatars are visual objects of a virtual world and represent individuals. Avatars are unique characters or virtual identities of users who participate in Internet chatting, online shopping, or an online game.

Avatars in a virtual world may not indicate any information regarding their users and are simply manipulated according to unilateral commands input by their users. Therefore, are accurately represented by their avatars in a virtual world.

A virtual world such as an online game or an Internet chat room may include a number of objects. For example, in the case of an online game, a region where mountains and valleys are located or an underground dungeon may be provided as a virtual world that can be explored by a game user.

However, users may desire to vividly reflect various aspects of the real world in a virtual world and to fully participate in such a virtual world. Therefore, it is desirable to develop a system and method for realizing a virtual world that can very closely reflect various aspects of the real world and the state of users.

### SUMMARY OF THE INVENTION

The present invention provides a method and system for creating a mixed world in which the state of an object in the real world can be effectively reflected into a virtual environment.

The present invention also provides a method and system for creating a mixed world in which a real state that represents the state of a user can be reflected in a mixed world that reflects the circumstances of the real world.

The present invention also provides a method and system for creating a mixed world which can enable various online activities (such as communication, transactions, and advertising) between users who participate in a mixed world.

However, the objectives of the present invention are not restricted to those set forth herein. The above and other objectives of the present invention will become apparent to one of ordinary skill in the art to which the present invention pertains by referencing the detailed description of the present invention given below.

According to an aspect of the present invention, there is provided a system for creating a mixed world that reflects a real state, the system including a mirror world creation module which creates a mirror world that represents the structure of the real world; an object information collection module which collects real object information; and a mixed world creation module which creates a mixed world by reflecting the real object information in the mirror world.

According to another aspect of the present invention, there is provided a method of creating a mixed world that reflects a real state, the method including creating a mirror world that represents the structure of the real world; collecting real object information; and creating a mixed world by reflecting the real object information in the mirror world.

### BRIEF DESCRIPTION OF THE DRAWINGS

The above and other features of the present invention will become apparent by describing in detail exemplary embodiments thereof with reference to the attached drawings in which:

FIG. 1 illustrates a block diagram of a system for creating a mixed world that reflects a real state, according to an embodiment of the present invention;

FIG. 2 illustrates a schematic diagram of a mirror world according to an embodiment of the present invention;

FIG. 3 illustrates a schematic diagram of avatars that can be used in the present invention;

FIG. 4A illustrates a screen image of a mixed world that can be output to a user device, according to an embodiment of the present invention;

FIG. 4B illustrates a screen image of a mixed world obtained by adding a new element of a virtual world to the mixed world of FIG. 4A;

FIG. 5 illustrates a flowchart of a method of creating a mixed world that reflects a real state, according to an embodiment of the present invention; and

FIG. 6 illustrates a flowchart of a method of creating a mixed world that reflects a real state, according to another embodiment of the present invention.

### DETAILED DESCRIPTION OF THE INVENTION

Aspects and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term ‘module’, as used herein, means, but is not limited to, a software or hardware component, such as a Field Programmable Gate Array(FPGA) or Application Specific Integrated Circuit(ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Hereinafter, embodiments of the present invention will be described in detail with reference to the attached drawings.

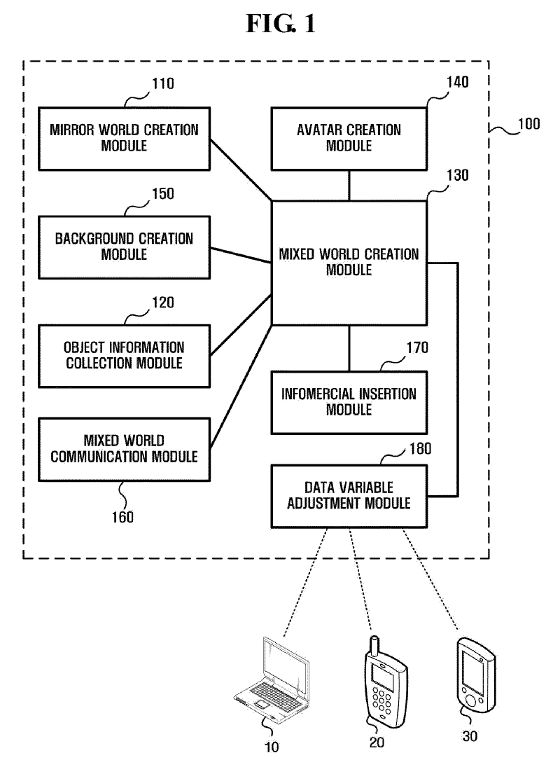

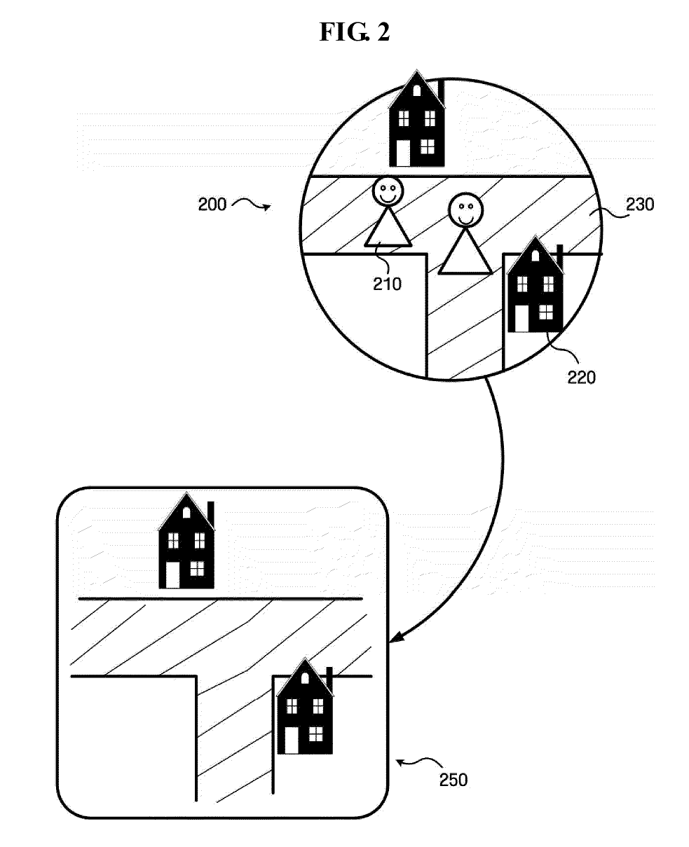

FIG. 1 illustrates a block diagram of a system 100 for creating a mixed world that reflects a real state, according to an embodiment of the present invention, and FIG. 2 illustrates a diagram of a mirror world according to an embodiment of the present invention.

Referring to FIG. 1, the system includes a mirror world creation module 110, an object information collection module 120, a mixed world creation module 130, an avatar creation module 140, a background creation module 150, a mixed world communication module 160, an infomercial insertion module 170, and a data variable adjustment module 180.

The mirror world creation module 110 creates a mirror world 250 by reflecting the structure of the real world 200 in a virtual world, i.e., by generating graphical representations of the structure of the real world 200 in the virtual world. The real world 200 is where users actually participate. Therefore, the real world 200 may include a variety of objects that constitute the space of reality. For example, referring to FIG. 2, the real world 200 may include objects such as buildings 220, roads 230, and people 210. The real world 200 may also include other various objects such as automobiles, motorbikes, bridges, rivers and mountains. The mirror world creation module 110 may create the mirror world 250 using a two-dimensional (2D) or three-dimensional (3D) graphics. In an exemplary embodiment, the structure of the real world 200 is an environment of the real world 200.

The mirror world creation module 110 creates the mirror world 250 that reflects the structure of the real world 200. For example, if a user is in a museum, the mirror world creation module 110 may create a mirror world 250 which reflects the structure of the museum and output the mirror world 250 to a user device of the user.

The mirror world creation module 110 reproduces the real world 200 or a structure in the real world 200 in a virtual world. The virtual world is a place or world realized on the screen of a user device. Users can participate in various online activities such as online conversation, online games, and online transactions in the virtual world.

If the location of the real world 200 is designated, the mirror world creation module 110 may create the mirror world 250 based on predefined structure data regarding the real world 200. Alternatively, the mirror world creation module 110 may create the mirror world 250 based on information collected from user devices 10, 20 and 30 regarding the real world 200.

Since the mirror world 250 can be provided to users of the user devices 10, 20 and 30, the users of the user devices 10, 20 and 30 can experience a heightened sense of reality when accessing a virtual world.

The object information collection module 120 collects real object information from the real world 200. The object information collection module 120 may collect the real object information in various manners. The real object information may include nearly all information regarding variability in the real world 200. For example, the real object information may include motion information of each of the users of the user devices 10, 20 and 30, weather information, and variable information such as automobile information regarding automobiles in the vicinity of the users of the user devices 10, 20 and 30.

The object information collection module 120 may receive the real object information from the user devices 10, 20 and 30 or from a sensor network in the vicinity of each of the users of the user devices 10, 20 and 30.

For example, if the real object information includes motion information such as location information, heading direction, and velocity information of the users of the user devices 10, 20 and 30, the object information collection module 120 may obtain the motion information from the sensors of the user devices 10, 20 and 30. If the user devices 10, 20 and 30 are equipped with a global positioning system (GPS) sensor, the locations of the users of the user devices 10, 20 and 30 in the real world 200 may be determined. Then, heading direction information and velocity information of the users of the user devices 10, 20 and 30 may be obtained from the trajectories of the users of the user devices 10, 20 and 30 over time. Alternatively, the user devices 10, 20 and 30 may be equipped with an accelerometer or an angular velocity sensor, and may thus be able to obtain motion information of the users of the user devices 10, 20 and 30. If the user devices 10, 20 and 30 are connected to a base station or a relay station, the user devices 10, 20 and 30 may receive location information of the user devices 10, 20 and 30 from the base station or the relay station and obtain motion information regarding the users of the user devices 10, 20 and 30. Then, the user devices 10, 20 and 30 may transmit the motion information to the object information collection module 120.

If the real object information includes weather information, the user devices 10, 20 and 30 may obtain weather information using the sensors of the user devices 10, 20 and 30 or from weather sensors that are placed in the real world 200. The weather information may include temperature and humidity information and weather condition information indicating whether it is cloudy or fine or whether it is raining. The user devices 10, 20 and 30 may transmit the weather information to the object information collection module 120.

The mixed world creation module 130 creates a mixed world 400 by reflecting the real object information collected by the object information collection module 120 into the mirror world 250 created by the mirror world creation module 11 0. More specifically, the mixed world creation module 130 may create the mixed world 400 by generating virtual representations of people in the real world 200 and weather and landscape changes in the real world 200 into the mirror world 250, which has a resemblance to the real world 200. The mixed world 400 is a virtual world which fully reflects not only the structural aspect but also the environmental aspect of the real world 200 and can thus provide a vivid sense of reality to users who participate in the mixed world 400. The mixed world creation module 130 may create the mixed world 400 using a 2D or 3D graphics.

The mixed world creation module 130 may create the mixed world 400 using real object information that reflects the real state of the real world 200. For example, the mixed world creation module 130 may place an avatar corresponding to a predetermined user in the mirror world 250 based on real object information. The avatar may be continuously updated according to motion information such as position, motion path and velocity information which is included in real object information collected from a user device.

The mixed world creation module 130 may create different mixed worlds for different users and/or for different user devices based on real object information acquired from the user devices of the different users.

The avatar creation module 140 may create avatars, which are virtual characters in a mixed world and represent actual users 210 in the real world 200.

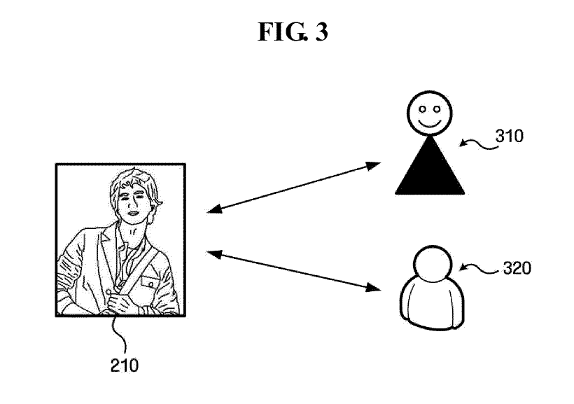

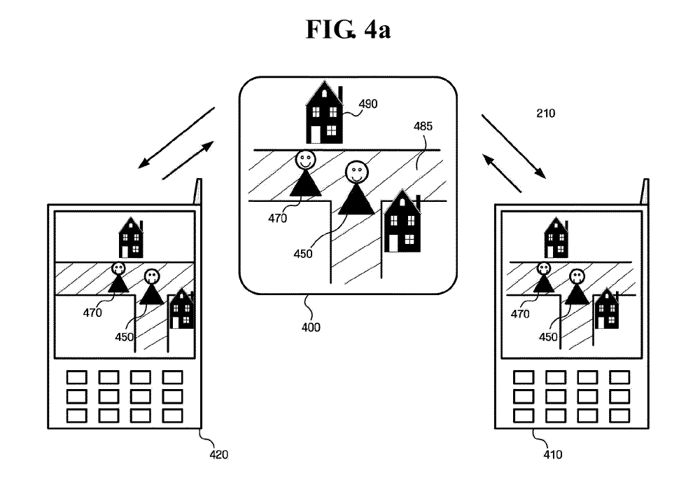

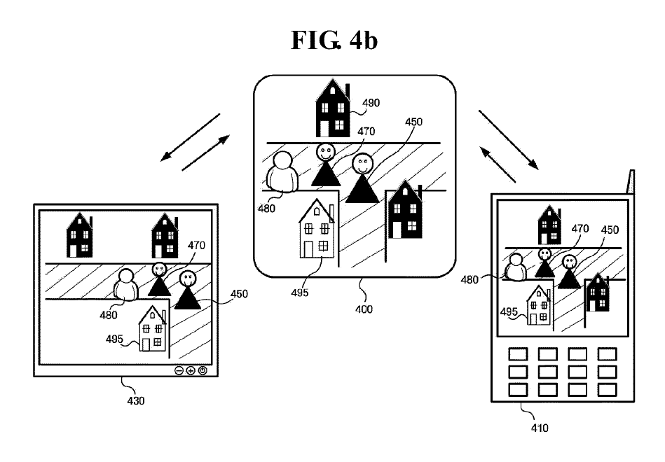

FIG. 3 illustrates a diagram of avatars according to an embodiment of the present invention, FIG. 4A illustrates a screen image of a mixed world which can be output to a user device, according to an embodiment of the present invention, and FIG. 4B illustrates a screen image of a mixed world obtained by adding a number of objects in a virtual world to a mixed world of FIG. 4A.

Referring to FIG. 3, avatars may be classified into a virtual avatar 320 and a real avatar 310. The virtual avatar 320 is a passive, dependent and non-intellectual avatar which can perform communication and reflect changes in the appearance or position of a user 210 according to a user command.

The real avatar 310, unlike the virtual avatar 320, can reflect changes in the appearance or position of the user 210 in real time not only according to a user command but also according to real object information. The real avatar 310 can allow the user 210 to perform bidirectional communication and is thus an active and intellectual avatar.

The virtual avatar 320 and the real avatar 310 may coexist in a mixed world 400. The real avatar 310 may move according to real object information. Even though the virtual avatar 320 and the real avatar 310 are illustrated in FIG. 3 as having different appearances, the virtual avatar 320 and the real avatar 310 may be designed to have the same appearance.

Referring to FIG. 4A, a mixed world 400 reflects dynamic features of a real world 200, such as first and second avatars 450 and 470 which represent users, into a mirror world 250 which represents static features of the real world 200 such as roads 485 and buildings 490. The mixed world creation module 130 may transform the mirror world 250 into the mixed world 400 by reflecting real object information collected by the object information collection module 120 into the mirror world 250.

Assume that only the first and second avatars 450 and 470 exist in the mixed world 400. The avatar creation module 140 may create the first and second avatars 460 and 470 using real object information. The mixed world creation module 130 may create the mixed world 400 in which the first and second avatars 450 and 470 can reside.

A first user device 410 may collect real object information from the real world 200 and transmit the real object information to the object information collection module 120. The first user device 410 may output the mixed world 400 to a first user. The first user may use the first avatar 450 to participate in a mixed world 400 that is created for the first avatar 450. Then, the first user may perform various online activities such as communication, conversation, transactions, and exchange of gifts with another user in the vicinity of the first user, i.e., a second user. If the first user keeps moving from one place to another in the real world 200, the first user device 410 may collect real object information such as motion information of the first user or information regarding the circumstances of the first user and transmit the real object information to the object information collection module 120. Then, the mixed world creation module 130 may update the mixed world 400 based on the real object information transmitted by the first user device 410 so that the first user can be provided with the updated mixed world 400 through the first user device 410.

The second user who holds a second user device 420 may be provided with a mixed world that is created for the second user through the second user device 420. The second user may perform various online activities such as communication, conversation, transactions, and exchange of gifts with another user in the vicinity of the second user, i.e., the first user. The second user device 420 may collect real object information such as motion information and emotion information of the second user and information regarding the circumstances of the second user and transmit the real object information to the object information collection module 120. In short, the mixed world creation module 130 may create a mixed world 400 by reflecting real object information into a mirror world 250.

As described above, the system 100 according to the embodiment of FIG. 1 reflects not only the structure of a real world but also the real state of the real world 200, thereby creating a mixed world with a vivid sense of reality. In addition, the system 100 according to the embodiment of FIG. 1 can enable users to perform various activities such as communication, transactions or exchange of gifts in a mixed world through their avatars.

The addition of a new element of a virtual world to the mixed world 400 illustrated in FIG. 4A will hereinafter be described in detail with reference to FIG. 4B.

FIG. 4B illustrates the situation when there is a third user who wants to participate in the mixed world 400 with a third user device 430. Referring to FIG. 4B, the third user device 430 may be a device equipped with no tool (such as a sensor) for collecting real object information.

A structure 495, which is a new element of a virtual world, may be added to the mixed world 400. The mixed world creation module 130 may create a mixed world 400 based on real object information, and add a new virtual structure or terrain to the mixed world 400.

If the third user enters the mixed world 400, the avatar creation module 140 may create a third avatar 480 for the third user. Even though the third avatar 480 is a member of the mixed world 400, the third user cannot collect real object information with his/her user device, i.e., the third user device 430. Thus, the real state of the third user cannot be reflected into the mixed world 400. Therefore, the third avatar 480, unlike the first and second avatars 450 and 470, is a virtual avatar.

The third avatar 480 may participate in various social activities such as communication, transactions, or exchange of gifts in the mixed world 400 along with the first and second avatars 450 and 470.

As described above, the atmosphere of the mixed world 400 may be easily varied by adding new elements to the mixed world 400 whenever a new user enters the mixed world 400 through his/her avatar. Users in the mixed world 400 can perform various social activities such as communication or transactions with one another in the mixed world 400 through their avatars.

Referring to FIG. 1, the avatar creation module 140 may control the facial expression or motion of an avatar based on emotion information of a user. The emotion information may be extracted from messages transmitted by the user. More specifically, the emotion information may be extracted from messages transmitted by the user or the voice tone of the user by using a collaborative filtering method.

The background creation module 150 provides a background to a mixed world 400 including a mirror world 250 and a number of avatars. The background creation module 150 may provide a background that reflects the circumstances of a user in a real world 200 to the mixed world 400. For example, if real object information indicating that it is currently snowing or raining in the real world 200 is received from a user device that, the background creation module 150 may reflect the real object information into the mixed world 400 so that it can appear that it rains or snows in the mixed world 400. If real object information indicating that it is foggy or tree leaves are being shaken by the wind is received from a user device, the background creation module 150 may create a background that offers the mixed world 400 the same effect as in the real world 200 based on the real object information.

The mixed world communication module 160 enables a user to communicate with other users through his/her avatar. That is, users may communicate with one another in the mixed world 400 through their avatars and one of text, voice, images and multimedia. Users may communicate with or send/receive instant messages to/from one another in the mixed world 400 using various communication methods such as a text-to-text, text-to-voice, voice-to-text, or voice-to-voice method.

The infomercial insertion module 170 may provide an advertisement or information to members of the mixed world 400. In order to provide customized information to members of the mixed world 400, a keyword-targeted advertising method in which a keyword is extracted from search words input by users and advertisements are selected based on the keyword may be used. Alternatively, external advertisements may be introduced into the mixed world 400 so that they can be easily spotted from the background of the mixed world 400. The infomercial insertion module 170 may provide various other information such as a system notification or breaking news.

The data variable adjustment module 180 controls data rate and the amount of data to be transmitted for each of the user devices 10, 20 and 30. The data variable adjustment module 180 may provide a data sink function for user devices having a weak connection to the mixed world 400. Also, the data variable adjustment module 180 may provide an optimized communication path, content and a user interface between different user devices.

The system 100 may also include a voice recognition module (not shown) which serves as a voice recognition engine when performing a voice-to-text messaging service; an emotion/motion generation module which generates avatar emotions or motions based on text written in a natural language by a user; and a voice generation module (not shown) which generates voice data based on text when performing a text-to-voice messaging service.

As described above, real object information that represents a real state of the real world is reflected into a mirror world, thereby creating a mixed world having a vivid sense of reality in a virtual world. Then, users can participate in various social activities such as communication, transactions, or exchange of gifts in the mixed world using their avatars. In addition, real object information such as the motion of a user, the circumstances of a user, and emotion information of a user is reflected into the mirror world, thereby making it possible to create a market or a community that can attract more users beyond the wall between a virtual world and a real world.

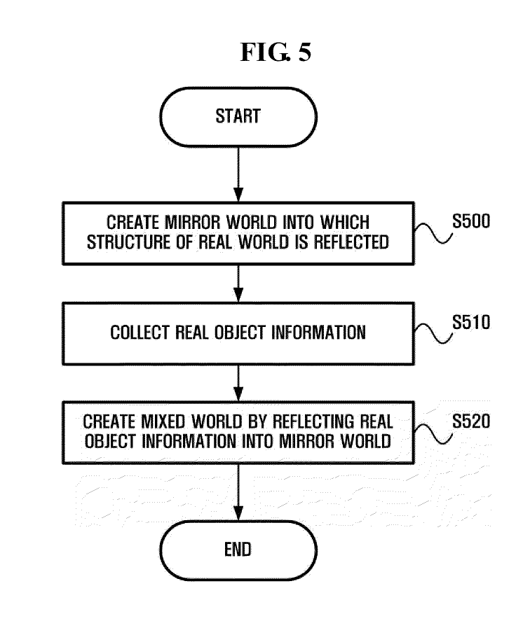

FIG. 5 illustrates a flowchart of a method of creating a mixed world that reflects a real state, according to an embodiment of the present invention. Referring to FIG. 5, a mirror world which represents the structure of a real world is created (S500). Once the location of each user who holds a user device is determined, a mirror world which represents the static structure of the real world is created.

Thereafter, the object information collection module 120 collects real object information (S510). A sensor of a user device may create real object information such as motion information of a user and weather information and transmit the real object information to the object information collection module 120. Alternatively, a sensor network may create real object information and transmit the object information collection module 120.

Thereafter, a mixed world is created by reflecting the real object information into the mirror world. The mixed world reflects dynamic features in the real world into the mirror world which represents the static structure of the real world in real time. Therefore, it is possible for a user to perform various online activities such as communication, transactions, exchange of gifts and creation of a community in the mixed world through his/her avatar created based on motion information included in real object information.

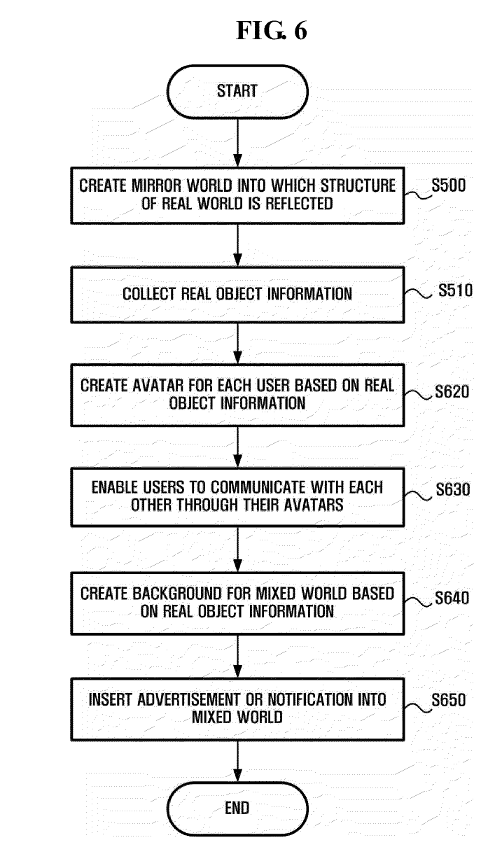

FIG. 6 illustrates a flowchart of a method of creating a mixed world that reflects a real state, according to an embodiment of the present invention. Referring to FIG. 6, a mirror world that reflects the structure of a real world is created (S500). Thereafter, the object information collection module 120 collects real object information (S510).

Thereafter, an avatar which represents a user in the real world is created based on the real object information. More specifically, the avatar creation module 140 may create an avatar in the mirror world using the real object information, and particularly, motion information (such as position and motion path information) of the user. Once the avatar is created in the mirror world, the mirror world is transformed into a mixed world in which the avatar can perform various activities. The avatar may be a real avatar which is active and intelligent enough to reflect changes in the appearance and position of the user in real time.

The avatar may communicate with other avatars in the mixed world (S630). More specifically, the user may communicate with other users through his/her avatar in the mixed world using one of text, voice, images and multimedia. In addition, the user may perform communication in various manners such as text-to-text, text-to-voice, voice-to-text, and voice-to-voice manners or transmit instant messages.

A background of the mixed world may be created or updated based on the real object information, and particularly, information regarding the circumstances of the user such as weather information (S640). More specifically, the user device of the user may observe weather and transmit weather information obtained by the observation to the background creation module 150. Then, the background creation module 150 may create a background for the mixed world based on the weather information.

An advertisement or notification may be inserted into the mixed world (S650). More specifically, an advertisement may be selected according to a keyword extracted from messages transmitted between users, and the selected advertisement may be inserted into the mixed world. Alternatively, an external advertisement may be inserted into the background of the mixed world.

As described above, a mixed world is created by reflecting not only static but also dynamic features of a real world into a virtual world. Therefore, it is possible for a user to create a market or a community that has a resemblance to the real world. In addition, it is possible for a user to perform various online activities such as communication, transactions, and advertising in a mixed world that reflects various aspects of the real world.

Moreover, it is possible to reflect the state of an object in the real world into a virtually established environment.

Furthermore, it is possible to provide a vivid representation of the real world as a mixed world by reflecting a real state that represents the state of a user into a mixed world.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for creating a mixed world that reflects a real state, the system comprising:
a mirror world creation module which creates a mirror world that represents a structure of a real world;
an object information collection module which collects real object information; and
a mixed world creation module which creates a mixed world by generating representations of real objects in the mirror world, based on the real object information.

2. The system of claim 1, wherein the mixed world creation module comprises an avatar creation unit which collects the real object information from user devices of a plurality of users and creates avatars for the plurality of users in the mixed world.

3. The system of claim 2, wherein the avatar creation unit controls motions or face expressions of the avatars based on the real object information.

4. The system of claim 2, further comprising a mixed world communication module, wherein the plurality of users communicate with one another with the avatars and one of text, voice, images and multimedia, through the mixed world communication module.

5. The system of claim 4, wherein the avatar creation unit controls facial expressions or motions of the avatars based on emotion information which are obtained by analyzing messages transmitted among the plurality of users.

6. The system of claim 1, wherein the mixed world creation module comprises a background creation module which updates a background of the mixed world based on the real object information.

7. The system of claim 1, wherein the object information collection module collects the real object information from user devices of a plurality of users, and the real object information comprises basic information of the plurality of users, motion information of the plurality of users or weather information.

8. The system of claim 1, further comprising an infomercial insertion module which inserts an advertisement or notification into the mixed world.

9. The system of claim 8, wherein the infomercial insertion module inserts an advertisement into the mixed world according to a keyword obtained by analyzing messages or user voices collected from user devices of a plurality of users.

10. The system of claim 1, wherein the object information collection module collects the real object information from user devices which are held by corresponding users, and the real object information comprises basic information of the corresponding users, motion information of the corresponding users or weather information.

11. A method of creating a mixed world that reflects a real state, the method comprising:
creating a mirror world that represents a structure of a real world;
collecting real object information; and
creating a mixed world by generating representations of real objects in the mirror world, based on the real object information.

12. The method of claim 11, further comprising collecting the real object information from user devices of a plurality of users and creating avatars for the plurality of users in the mixed world.

13. The method of claim 12, wherein the creating of the avatars comprises controlling motions or facial expressions of the avatars based on the real object information.

14. The method of claim 12, wherein the plurality of users communicate with one another with the aid of the avatars and one of text, voice, images and multimedia.

15. The method of claim 13, wherein the creating of the avatars further comprises analyzing messages transmitted among the plurality of users and controlling the facial expressions or the motions of the avatars based on emotion information obtained by the analyzing messages.

16. The method of claim 11, further comprising updating a background of the mixed world based on the real object information.

17. The method of claim 11, wherein the collecting of the real object information comprises collecting the real object information from user devices of a plurality of users, and the real object information comprises basic information of the plurality of users, motion information of the plurality of users or weather information.

18. The method of claim 12, further comprising inserting an advertisement or a notification into the mixed world.

19. The method of claim 18, wherein the inserting of the advertisement or the notification comprises analyzing messages or user voices collected from the user devices of the plurality of users and inserting an advertisement into the mixed world according to a keyword obtained by the analyzing messages.

20. The method of claim 11, wherein the collecting of the real object information comprises collecting the real object information from user devices which are held by corresponding users, and the real object information comprises basic information of the corresponding users, motion information of the corresponding users or weather information.
